(19) United States
(12) Patent Application Publication
(10) Pub. No.: US 2021/0283763 A1
(43) Pub. Date: Sep. 16, 2021

(54) ASSEMBLY HAVING A CAPTIVE SCREW

(71) Applicant: Hilti Aktiengesellschaft, Schaan (LI)

(72) Inventor: Rory BRITZ, Buchloe (DE)

(21) Appl. No.: 17/260,062

(22) PCT Filed: Aug. 7, 2019
(86) PCT No.: PCT/EP2019/071183

§ 371 Date: Jan. 13, 2021

(30) Foreign Application Priority Data
Aug. 13, 2018 (EP) 18188655.7

(51) Int. Cl. B25F 5/02; F16B 5/06; F16B 37/00; F16B 41/00

(52) U.S. Cl. CPC B25F 5/02; F16B 41/002; F16B 37/005; F16B 5/0642

(57) ABSTRACT

The assembly 1 has a screw 4, an upper part and a lower part. The upper part has an upper side 17, a first hole 23, extending through the upper side 17, for pushing through the screw 4. An open diameter of the first hole 23 is larger than a diameter of the screw neck 8. The upper part 3 has a collar 24 which projects axially from the upper side 17 and is arranged around the first hole 23, and an outside diameter of the collar 24 is equal to or smaller than the diameter of the screw head 7.

### FIELD OF THE INVENTION

The invention relates to an assembly having a captive screw.

### BACKGROUND

In portable power tools, screw fastenings are used to connect housing shells, to fasten covers and to connect assemblies. Some of the screw fastenings are intended to be reopened. A cover can be screwed off to change carbon brushes of an electric motor, for example. The problem here is that the unscrewed screws can easily be lost and that a replacement may not necessarily be immediately available.

### SUMMARY OF THE INVENTION

The assembly according to the invention secures its screws after they have been tightened for the first time. The assembly requires only the screw and the two parts to be connected, which are referred to below as the upper part and the lower part. The complexity of first-time assembly during the fabrication of the assembly is not increased by additional securing elements.

The assembly according to the invention has a screw, an upper part and a lower part. The screw has a screw head, a screw neck and a screw thread. The upper part has an upper side, a first hole, extending through the upper side, for pushing through the screw. An open diameter of the first hole is larger than a diameter of the screw neck. The lower part has a second hole for receiving and screw-fastening the screw. The upper part has a collar which projects axially from the upper side and is arranged around the first hole, and an outside diameter of the collar is equal to or smaller than the diameter of the screw head.

In the method according to the invention for screw-fastening the assembly, the upper part is placed on the lower part, wherein the first hole of the upper part is aligned on the same axis as the second hole of the lower part. The screw is pushed through the first hole into the second hole. The screw is screw-fastened in a screw boss of the lower part. As the screw is tightened, the axially projecting collar is plastically deformed into a bead projecting radially into the first hole. During this process, the diameter of the first hole becomes too small for the screw to be pulled out of the hole again.

The collar is not a separate part but is materially integral with or composed of the same material as the upper part.

### BRIEF DESCRIPTION OF THE FIGURES

The following description explains the invention on the basis of exemplary embodiments and figures, in which:

FIG. 1 shows a segment of an assembly before first-time screw-fastening

FIG. 2 shows a plan view of the upper part before first-time screw-fastening

FIG. 3 shows a segment of a detail view of the assembly in the screw-fastened state

FIG. 4 shows a segment of the assembly with the screw fastening released

FIG. 5 shows a hammer drill

Identical or functionally identical elements are indicated by the same reference numerals in the figures, unless stated otherwise. A diameter refers to the outside diameter unless stated otherwise.

### DETAILED DESCRIPTION

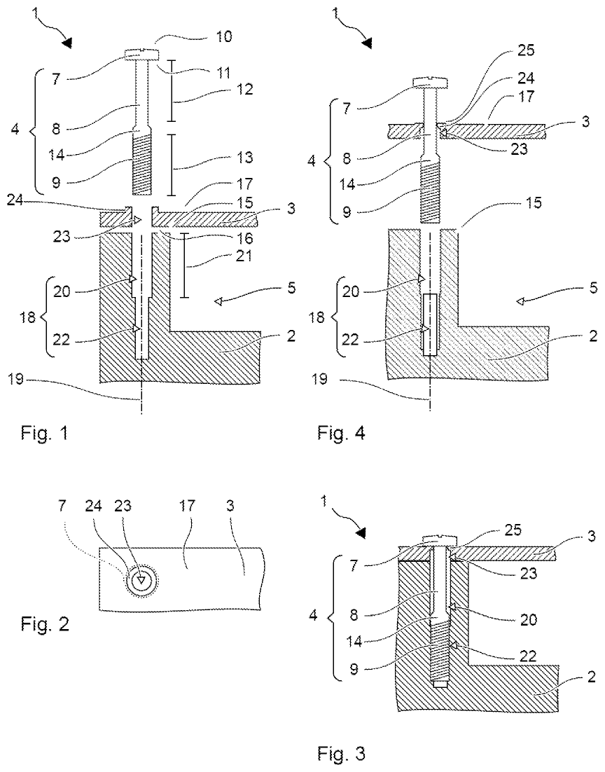

An assembly 1 contains a lower part 2, an upper part 3 to be fastened on the lower part 2 and a screw 4, which fastens the upper part 3 on the lower part 2. The lower part 2 is, for example, a housing having a cavity 5, and the upper part 3 is a cover for the cavity 5. An illustrative assembly 1 for a portable power tool 6 is described with reference to FIG. 1 before first-time screw-fastening, with reference to FIG. 3 in the screw-fastened state and with reference to FIG. 4 after the opening of the screw fastening. Of the assembly 1, only a segment of the lower part 2 and the upper part 3 is illustrated. Moreover, the assembly 1 can contain more than one screw 4. The screw fastening of the assembly 1 can be released using a screwing tool, thereby enabling the upper part 3 to be removed completely from the lower part 2. However, the screw 4 remains trapped in the upper part 3. The screw 4 can only be removed from the upper part 3 by force and by destroying the latter. In this way, the risk of losing the screw 4 is reduced in an effective manner.

The screw 4 has a screw head 7, a screw neck 8 and a screw thread 9. An upper side 10 or a circumference of the screw head 7 is configured in such a way that a screwing tool can engage positively in the screw head 7 or fit positively around the screw head 7. Examples of a screw head 7 contain a slot, cross slot, torx, etc. on the upper side 10 and/or have a hexagonal circumference. A lower side 11 of the screw head 7 is preferably flat. In the assembled state, the lower side 11 rests on the upper part 3. A diameter of the screw head 7 is larger than a diameter of the screw neck 8 and is typically also larger than a diameter of the screw thread 9.

The screw thread 9 can be of cutting or self-tapping design or designed for a precut thread. In the embodiment illustrated, a diameter of the screw thread 9 is larger than the diameter of the screw neck 8. A length of the screw thread 9 can be designed to match a tensile load to be applied by the screw 4.

The screw neck 8 is arranged between the screw head 7 and the screw thread 9. The screw neck 8 is a substantially cylindrical section. A length 12 of the screw neck 8 is preferably equal to or greater than the length 13 of the screw thread 9.

On both sides of the screw neck 8, the screw 4 has sections, the diameters of which are larger than the diameter of the screw neck 8. In the example illustrated, these two sections are the screw head 7 and the screw thread 9. The screw head 7 preferably directly adjoins the screw neck 8. A shoulder 14 is preferably provided between the screw neck 8 and the screw thread 9. The shoulder 14 can be of cylindrical, conical or any other rotationally symmetrical configuration. The shoulder 14 does not have a thread, in particular a cutting or self-tapping thread. A diameter of the shoulder 14 is larger than the diameter of the screw neck 8. A diameter of the screw thread 9 can be equal to, greater than or smaller than the diameter of the shoulder 14.

The lower part 2 has an upper side 15, on which a lower side 16 of the upper part 3 rests. The upper part 3 has an upper side 17, which faces away from the lower side 16. Typically, the lower side 16 and the upper side 17 are parallel to one another, at least close to the screw-fastening region. The designations “upper” and “lower” are chosen with reference to the direction in which the screw 4 is used and should not be interpreted as restrictive in respect of an orientation of the lower part in space. Moreover, the upper part 3 can rest on several sides of the lower part, e.g. if the upper part 3 is angled.

The lower part 2 has a hole 18 extending through the upper side 15, in which the screw 4 is partially accommodated. The hole 18 extends along an axis 19. The hole 18 has a stepped diameter along the axis 19.

A first section 20 adjoining the upper side 15 is designed in such a way that the screw thread 9 can be inserted fully into the first section 20. The screw thread 9 can be moved freely along the axis 19 in the first section 20, i.e. without the expenditure of force and without necessarily turning the screw thread 9 about the axis 19 during this process. The screw thread 9 can be guided by the first section 20. However, the screw thread 9 does not engage in the wall of the first section 20. An open cross section of the first section 20 is accordingly equal to or larger than the cross section of the screw thread 9. If the shoulder 14 is provided on the screw 4, the open cross section is accordingly larger than the larger of the two cross sections of the screw thread 9 and the shoulder 14. The open cross section can be of circular, elliptical, square, rectangular or some other configuration. Typically, the first section 20 has a constant open cross section along the axis 19. A length 21 of the first section 20 is equal to or somewhat greater than the length 13 of the screw thread 9.

A second section 22 remote from the upper side 15 is referred to below as screw boss 22. The screw boss 22 is designed for the screw-fastening of the screw 4 to the lower part 2. The screw boss 22 can be designed with a precut internal thread for the screw thread 9, for a self-tapping screw thread 9, for a cutting screw thread 9, etc. In contrast to the first section 20, the screw thread 9 engages in the wall of the screw boss 22 and cannot be moved freely along the axis 19. An open cross section of the screw boss 22 is smaller than the cross section of the screw thread 9 and accordingly smaller than the open cross section of the first section 20. A length of the screw boss 22 can be equal to or greater than the length 13 of the screw thread 9. In other embodiments, the screw boss 22 can be shorter if the screw boss 22 is adjoined by a further cavity or an opening 5, into which a part of the screw thread 9 can project.

The upper part 3 has a through hole 23 (eye) from the upper side 17 to the lower side 16. The eye 23 has an open cross section which is smaller than the diameter of the screw head 7 and larger than the largest cross-section of the other sections of the screw 4, e.g. of the screw thread 9. The open cross section is larger than the cross section of the screw neck 8. The eye 18 is typically hollow-cylindrical. The screw 4 can be pushed through the eye 23 until the lower side 11 of the screw head 7 comes to rest on the upper part 3.

The upper part 3 has a collar 24 projecting from the upper side 17 as an extension of the eye 23. The collar 24 is arranged around the eye 23. The collar 24 is preferably in the form of a closed ring. An inside diameter of the collar 24 is smaller than the diameter of the screw head 7. However, the inside diameter is larger than the largest cross section of the other sections of the screw 4, e.g. of the screw thread 9. The screw 4 can thus be pushed through the collar 24 and the hole 18 until the lower side 11 of the screw head 7 comes to rest on the collar 24. An outside diameter of the collar 24 is preferably equal to or smaller than the diameter of the screw head 7, which is illustrated in dashes in FIG. 2.

A height of the collar 24 is chosen so that, as the screw 4 is tightened, the elastic limit of the material is exceeded when the screw head 7 is resting on the upper side 17 of the upper part 3. A mean thickness of the upper part 3 away from the collar 24 is typically in a range of from 1.5 mm to 3 mm. The height of the collar 24 corresponds to 25% to 50% of the thickness of the upper part 3.

The collar 24 is formed integrally on the upper side 17 of the upper part 3. There is no boundary surface or joining surface between the collar 24 and the upper part 3. The collar 24 is composed of the same material as the upper part 3, or at least of the same material as the upper side 17 of the upper part 3. The collar 24 can be composed of a polymer or a metal.

The assembly 1 with the lower part 2 and the upper part 3 can be connected to one another by one screw 4 or by several of these screws. FIG. 3 shows the assembly 1 in the screw-fastened state. For screw-fastening, the hole 18 of the lower part 2 and the eye 23 of the upper part 3 can be aligned with one another along the axis 19. The screw 4 is inserted through the eye 23 into the hole 18. The screw 4 is screwed into the screw boss 22 using a screwing tool. During this process, the screw head 7 is lowered onto the upper side 17 of the upper part 3. The collar 24 is of such soft design that the tensile force applied by the screw 4 leads to plastic deformation of the collar 24. The material of the collar 24 flows at least partially into the eye 23. A bead 25 forms in the eye 23. The bead 25 reduces the diameter of the eye 23 in a region adjoining the upper side 17. The geometrical configuration of the bead 25 in the direction of the upper side 17 and in the radial direction is substantially determined by the screw head 7 and the screw neck 8. The bead 25 has an annular configuration, the open inside diameter of which corresponds to the diameter of the screw neck 8. A lower side of the bead 25 is typically uneven. Furthermore, the lower side of the bead and hence the bead 25 per se can have a configuration which is not rotationally symmetrical. The volume of the collar 24 is preferably chosen so that the bead 25 which forms from the collar 24 extends over only part of the height of the eye 23, e.g. over less than 75%, less than 50%, or less than 25% of the height of the eye 23. The height denotes the dimension along the axis 19.

The screw fastening can be released with a screwing tool. The screw thread 9 is unscrewed from the precut or now tapped or cut internal thread until the screw thread 9 is no longer in engagement. During this process, the screw head 7 can come away from the upper side 17. The screw neck 8 can preferably be moved along the axis 19 in the eye 23. The upper part 3 can then be lifted off the lower part 2 (FIG. 4). However, the screw 4 cannot be removed from the upper part 3. The screw thread 9 can no longer be pulled out through the narrowed eye 23. The bead 25 is permanent and is not reversed. The material of the previous collar 24 has been plastically deformed.

The screw neck 8 can expediently be moved in the eye 23 over its entire length 12, thereby ensuring that, in the case of several screws 4, these can be unscrewed individually and can also be screwed in again individually later.

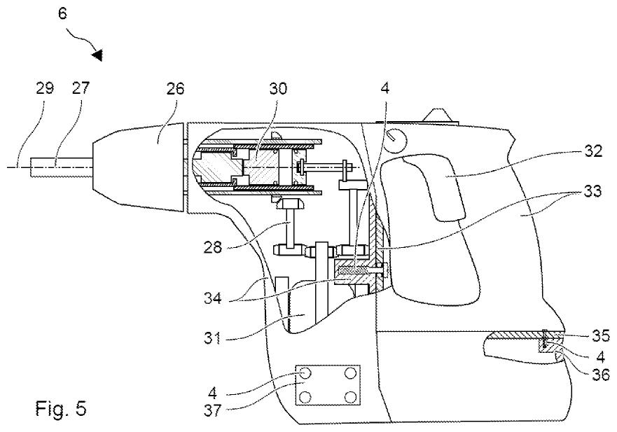

FIG. 5 schematically shows a hammer drill 6 as an example of a hand-held portable power tool having the assembly 1. The illustrative hammer drill 6 has a tool holder 26, into which a tool 27 can be inserted and locked. The tool 27 is, for example, a drill, a chisel etc. The embodiment illustrated by way of example turns the tool holder 26 by means of a rotary drive 28 about a working axis 29 and simultaneously exerts periodic blows on the tool along the working axis 29 by means of a pneumatic striking mechanism 30. The rotary drive 28 and the striking mechanism 30 are preferably driven by an electric motor 31. The user can put the portable power tool 6 into operation by means of an operating button 32, i.e. can switch on the electric motor 31. The portable power tool 6 has a handle 33. The user can hold and guide the portable power tool 6 during operation by way of the handle 33. The operating button 32 is preferably attached to the handle 33 in such a way that the user can operate the operating button 32 using the hand holding the handle 33.

The portable power tool 6 has housing components which are connected to one another in the form of the assembly 1. Examples of the pairing comprising a lower part 2 and an upper part 3 are the housing 34 and the handle 33, the transmission block and the housing 34, the battery casing 35 and the battery cover 36, the left-hand housing shell and the right-hand housing shell, and the motor compartment and the window 37 for access to the motor compartment. The screw fastening is used to fix the upper part 3 on the lower part 2. The upper part 3 and the lower part 2 can furthermore be connected movably to one another by a tab etc.

The use of the captive screw fastening in the hammer drill illustrated is illustrative. Other portable power tools comprise electric screwdrivers, power drills, chipping hammers, circular saws, jig saws, reciprocating saws, cut-off grinders, setting tools etc. Depending on the drive train, the tool holder transmits to the tool a continuously rotating movement, a pulse-like rotating movement, an axially striking movement, a pendulum movement or a superimposition of these movements. The drive can comprise an electric motor, an internal combustion engine or other concepts for moving a tool or consumable.

1-8. (canceled)

9. An assembly comprising:
a screw having a screw head, a screw neck and a screw thread;
an upper part having an upper side, a first hole extending through the upper side for accepting the screw when pushed through, an open diameter of the first hole being larger than a screw neck diameter of the screw neck;
a lower part having a second hole for receiving and screw-fastening the screw;
the upper part having a collar projecting axially from the upper side and arranged around the first hole, and an outside diameter of the collar being equal to or smaller than a screw head diameter of the screw head.

10. The assembly as recited in claim 9 wherein the upper part and the collar are composed of a same material.

11. The assembly as recited in claim 10 wherein the upper part and the collar are composed of a polymer.

12. The assembly as recited in claim 9 wherein the collar is connected in a materially integral way to the upper part.

13. The assembly as recited in claim 9 wherein the diameter of the first hole on a side adjoining the screw head is smaller than the diameter of the first hole on a side of the upper part facing away from the screw head.

14. The assembly as recited in claim 9 wherein a bead connected in a materially integral way to the upper part reduces the open diameter of the first hole.

15. A portable power tool comprising the assembly as recited in claim 9.

16. A method for screw fastening the assembly as recited in claim 9, the method comprising the following steps:
placing the upper part on the lower part, wherein the first hole of the upper part is aligned on a same axis as the second hole of the lower part;
pushing the screw through the first hole into the second hole;
screw-fastening the screw in a screw boss of the lower part;
tightening the screw, the axially projecting collar being plastically deformed into a bead projecting radially into the first hole.
